(19) United States
(12) Patent Application Publication
(10) Pub. No.: US 2008/0307625 A1
(43) Pub. Date: Dec. 18, 2008

(54) Method for Removing Anode Residues Attached to Spent Anodes Coming from Melt Bath Electrolysis Potlines

(75) Inventor: Didier Lescarcelle, Lambres Les Douai (FR)

Correspondence Address: DENNISON, SCHULTZ & MACDONALD, 1727 KING STREET, SUITE 105, ALEXANDRIA, VA, 22314, US

(73) Assignee: E.C.L., Ronchin (FR)

(21) Appl. No.: 12/097,094

(22) PCT Filed: Dec. 14, 2006
(86) PCT No.: PCT/FR2006/002730

§ 371 Date: Jun. 30, 2008

(30) Foreign Application Priority Data
Dec. 16, 2005 (FR) 0512810

(51) Int. Cl. B23P 6/00; B23P 19/00

(52) U.S. Cl. 29/402.08; 29/763

(57) ABSTRACT

A process for extracting the anode butt (110) and the thimbles (130) attached to a spent anode or to a rejected new anode, including the following stages:
a) the butt (110) is fitted between a stop device (200) and an attacking device (300) said stop device having a first stop (211) blocking the butt, said attacking device being provided, around each stub, with a recess presenting a second stop (225) which blocks said thimbles, the axial distance between the stops being equal to, or greater than, the height of the thimbles;
b) the butt is moved so that it come us against the first stop;
c) the attacking device is moved: the butt breaks up;
d) the fragments of butt are removed;
c) the attacking device continues to move: the thimbles are detached from the stubs;
f) the attacking device stops and is withdrawn.

In two successive, clearly separated stages, the butt fragments and the thimbles are detached, fall and can be sent directly to a special recycling unit.

### TECHNICAL FIELD

The invention relates to the pstemuction of aluminum using igneous electrolysis. It more particularly relates to a process for removing the carbonaceous blocks and the metal bushings stuck to the anode stems in order to re-use the anode stems and legs cleaned in this way and to recycle the materials removed. This process mainly concerns the removal of leftover fragments of spent anodes but it may also concern the stripping of defective new anodes.

### BACKGROUND OF RELATED ART

Aluminum is pstemuced industrially by igneous electrolysis, namely by electrolysis of alumina in solution in a molten cryolite bath, known as an electrolyte bath, using the Hall-Héroult process. The electrolyte bath is contained in tanks, called “electrolysis tanks”, which include a steel container coated on the inside with refractory and/or insulating materials, and a cathodic unit located at the bottom of the tank. Anodes, typically made of carbonaceous material, are fixed to a superstructure equipped with means allowing them to be moved vertically, said anodes being consumed gradually during the electrolysis process. The assembly formed by an electrolysis tank, its anodes and the electrolyte bath is called an electrolysis cell. The anodes include a conducting metal stem, in conjunction with a device for fixing to said superstructure and with an electrical connection device, and a block made of carbonaceous material which constitutes the body of the anode and which is intstemuced into the electrolyte bath. The connection between the anode stem and the carbonaceous material body is made via a leg, typically made of steel, interdependent with the base of the stem and which in general has the shape of an upside-down candelabrum, each branch of the candelabrum being associated with a cylindrical end, the axis of which is parallel to the stem and which is known as a “stub” In general, these stubs are inserted inside recesses made on the top face of the block of carbonaceous material and the gaps between the stubs and bores are filled with molten metal, typically cast iron. The metal bushings made in this way—also called “thimbles”—make it possible to ensure good mechanical attachment and good electric connection between the stem and the block of carbonaceous material.

When operating, an electrolysis plant requires regular replacement of the anodes which are consumed throughout the aluminum pstemuction process. Regeneration of a spent anode is an economically necessary operation which involves removing the cooled electrolyte bath stuck to the anode butt (residual carbon block), then removing the butt and the thimbles to recycle them, and finally cleaning and if necessary rectifying the unit made up of the stem and the leg of the anode in order to associate it with a new block of carbonaceous material and thereby to obtain a new anode. In addition, certain new anodes (typically 1 to 2% of them) may be defective, for example a cracked block of carbon, so that they have to be put on one side to be returned and recycled directly with the spent anodes, without ever having been inserted into the electrolysis cells.

Until now, the thimbles and butts were generally removed using strippers working from top to bottom, the anode being held in vertical position. The anode legs were more or less directly subjected to the forces exerted by the stripping machine and their lifespan was very short.

In general, the strippers were specialized, some used to remove only the block of carbon (“anode butt strippers”), others to remove only the thimbles (“thimble strippers”). For example, the German patent application DE 41 28 522 describes an anode butt stripper in which the stripper and a bearing device are inserted between the remaining fragment of anode and the cross branches of the anode leg, the bearing device being placed in contact with the lower face of said branches and protecting these when the stripper is actuated downwards to break up the anode butt. The anode butt stripper described in application DE 41 28 522 also includes a device in the shape of knife which is actuated from bottom upwards at the end of the anode butt stripping operation to break up and remove the final pieces of the anode fragments still fixed to the stubs. The international application WO01/57291 describes a thimble stripper in which the stripper appears as a set of slender punches, placed under the stubs and in line with them, of smaller diameter than that of the stubs and acting upwards, the top face of the thumbles being blocked by a stop so that, when the punches move up, the thumbles bend and are detached from the stubs, while remaining trapped by the slender punches.

Patent application GB 1 269 809 describes a system comprising a hydraulic stripper acting downwards and lateral hydraulic chucking devices. This system has the advantage of proposing to remove the carbon blocks (anode butt stripping) and also the thimble (thimble stripping) in a single operation with the same machine. The special stripper in this request consists of a ram which strikes the butt to break up it, said ram being provided with a scraper which, moving in the vicinity of the stub, makes it possible to bend and detach the thimbles.

Patent application WO96/25536 takes up the idea of anode butt stripping and thimble stripping carried out by the same machine as that proposed in GB 1 269 809, and also the idea of the tooling attacking the carbon block from bottom to top already suggested in DE 41 28 522. Placed between a fixed plate and the tools, the anode fragment is subjected to such strain that it breaks up and then breaks away from the anode leg. But the butt fragments and the thimbles are removed in bulk and the waste has afterwards to be sorted. In addition, the fixed plate acts as an unevenly distributed stop depending on the stubs, and, in particular during thimble stripping, it causes large lateral forces likely to seriously damage the legs, or even the stems of the anodes.

The German patent application DE 44 10 599 also takes up the idea of anode butt stripping and thimble stripping carried out with the same machine. For each stub concerned, it proposes a stop device which at least partially surrounds said stub and a stripper punch, the stop device and the punch being mobile in relation to the stub and able to move towards each other by means of an actuator. By means of a recess worked into the stop device and which surrounds the stub, with a diameter greater than that of the thimble, the punch initially breaks up the butt, removes the butt fragments and then bends and detaches the thimbles.

This latter process has the advantage of carrying out anode butt stripping and thimble stripping with a single machine while separately recovering the fragmented butt blocks and the thimbles. It does, however, have two disadvantages:

a) as many devices of this type are required as there are stubs and this poses a real problem of size, in particular with the system for which the claim is made where the stop device and the punch are placed at the ends of substantially horizontal tool arms and swiveling towards each other around a common horizontal axis, like the arms of an enormous grip;
b) during anode butt stripping the forces are such that large blocks of carbon material may be detached, drawing thimbles with them, so that, as the crushing devices used for recycling the carbon material are fragile, it is necessary to inspect the recovered butt fragments, to recognize and isolate the large blocks containing thimbles, to extract them from the batch in order to continue fragmentation and to recover the thimble(s).

The purpose of the invention is to define a process for removing butts and thimbles from the spent anodes (or new rejected ones) which uses a single device but does not have the disadvantages presented above, in particular a device which allows waste to be sorted effectively so as to avoid the use of heavy and costly equipment such as special crushers and/or magnetic separators.

### DESCRIPTION OF THE INVENTION

A first subject according to the invention is a process making it possible to extract the anode butt and thimbles stuck to a spent anode, including the following stages:
a) the butt of the spent anode is placed between a stop device and an attacking device, said attacking device being able to be moved by means of an actuator towards said stop device, said stop device surrounding, at least partially, each stub of the anode stem leg and having a first stop preventing the butt from moving forward, said stop device being provided, around each stub, with a recess with a second stop which prevents said thimbles from moving forward;
b) the spent anode is moved until the butt is blocked by the first stop;
c) the attacking device is moved towards the stop device so that it arrives in contact with said anode butt and imposes on said butt such a force as to cause it to break up and the fragments to be detached from the butt;
d) the fragments of butt are removed;
e) the attacking device continues to move so that the thimbles are blocked by the second stop and are detached from the stubs;
f) the attacking device stops and is withdrawn;
   said process being characterized in that the axial distance between said first stop and said second stop is higher or substantially equal to the height of said thimbles.

When the butt has been sufficiently broken up and can no longer be held back by the first wall, the stubs move forward under the effect of the attacking device as it advances inside said recesses dragging with it portions of butt still fixed to the thimbles. At the end of the anode butt stripping operation, the thimbles can move from the first stop to the second stop, covered by a kind of carbonaceous matter sleeve. Throughout this rise, the length of which is proportional to the height of the recess, the thimble undergoes little mechanical strain while the last carbon fragments fall. This makes it possible to easily separate the two stripping phases and thereby facilitates separate reception of the carbonaceous fragments and the thimbles.

Preferably, the recess has a general shape which bears on a cylinder that is coaxial with the stub. Its diameter typically exceeds that of the thimble by about twenty millimeters. The side wall of the recess may have a surface condition such that it can retain carbonaceous material (relief in the bore, such as ridges, ribs, typically helix shaped, etc. . . . ), thereby generating shearing likely to complete fragmentation of the pieces of butt still attached to the stub.

Preferably also, the attacking device is provided with means of attack which include at least axial protuberances which, when the butt is no longer attached to the first stop—i.e. at the end of anode butt stripping and during thimble stripping—are substantially in line with each stub. In this way, the forces generated by the attacking device are substantially axial and the thimbles are less likely to be detached from the stubs, as long as they are not blocked by the second stop.

The process according to the invention is used after initial cleaning of the spent anode which involves removing the electrolyte bath which remains attached to the butt. The spent anode is then sent to the anode butt stripping and thimble stripping machine where the butt is placed between a stop device and an attacking device.

The attacking device can be moved using at least one actuator, typically a hydraulic actuating cylinder. Movement may be a simple translation, as in WO96/25536, or a rotation around a horizontal axis as in DE 44 10 599. In fact, movement is along a substantially constant unspecified direction, globally defined by the pairing of the relative position of the attacking device in relation to the stop device, the attack needing to be substantially frontal. In the following, movements in this direction will be termed “axial” movements. In practice, the vertical direction is chosen, which makes it possible to avoid having to set up an additional anode handling device. The spent anode is generally transported using an overhead conveyor, vertically, i.e. fixed to the conveyor by the top end of its stem. Once placed in said machine, its stem is held by holding means, typically centering grips, which allow axial movement of the stem, the stem leg needing to be able to move in this direction when it is reached by the attacking device. In order to allow said axial movement, the means of maintenance are advantageously provided, on contact with the stem, with pads having a low friction coefficient. Choosing a vertical direction makes it additionally possible to use gravity to recover waste. In this case, the attacking device is advantageously actuated by a set of jacks located outside the waste fall and reception zone.

The attacking device advantageously has axial protuberances which, at least at the end of anode butt stripping and during thimble stripping, are substantially in line with each stub. Preferably, the attacking device according to the invention will be provided with two different resources:

a) pointed protuberances, typically in the shape of pyramids or knives, which are not placed in the axis of the stubs so as to attack the butt at the start of anode butt stripping in areas far from the stubs, and
b) punches, which finish anode butt stripping in the sense that they complete the breaking-up of the butt fragments stuck around the stubs and are then used for thimble stripping. Advantageously, said punches have a round end with a diameter lower than that of the stubs. They are placed line with said stubs when they come into contact with them. They are preferably truncated and of low slenderness ratio.

Preferably, the pointed protuberances, or knives, are arranged according to one or more planes of symmetry of the geometrical configuration made up by the layout of the stubs, which allows the butt to be attacked satisfactorily from the spatial distribution standpoint, thereby avoiding setting up lateral forces likely to bend the stem leg. Preferably, the punches are in the shape of a truncated cone and have a low slenderness ratio (ratio between the height and the average diameter typically less than 1). In this way, they are more robust and do not trap the thimbles once they are detached from the stubs. The taper of the side wall makes it possible to “burst” the thimbles as the punch moves forward towards the second stop. This bursting can also be helped by equipping this truncated side wall with radially projecting edges to encourage fracturing.

Said stop device at least partially surrounds the stubs, with a gap: in particular, under the effect of the movement of the attacking device, it is imperative that the stem, the stem leg and the stubs can move axially whereas the butt and/or the thimbles are blocked. Said stop device surrounds each stub at least partially; it has a first stop arranged so that it stops the butt from moving forward axially and a second stop axially offset in relation to the first and arranged so that it stops the thimbles from moving forward axially. In general, the first and second stop only partially surround the stubs, so that the stop device can let the transverse branches of the anode stem leg in the shape of an upside-down candelabrum pass freely. However, as the forces generated during thimble stripping are very great, it is advantageous to pstemuce a device which, while letting the transverse branches of the anode stem leg pass freely, is provided, at least during thimble stripping, with a second stop which surrounds the stub completely. The device described in the example below is provided with a second stop which completely surrounds the stub at the start of anode butt stripping.

The stop device according to the invention can be made in a single piece, like the plate described in DE 41 28 522 including as many notches as there are stubs. In other words, it can be a thick plate of which one face, corresponding to the first stop, is provided with recesses surrounding the stub, the bottom of which corresponds to the second stop. However, such a plate would, according to the invention, be very thick, since the difference of the levels between the first and the second stop alone is substantially equal to the height of the thimbles, which is typically about 130 mm. A thinner plate can advantageously be used but it must be sufficiently solid as to withstand the forces generated by the stripping phase, this plate having a face that does duty as a second stop and to which are fixed, around the notches intended for the stubs, and at least partially surrounding said stubs, axial walls, typically in the shape of a cylinder or prism, of which the height is substantially equal to the height of the thimbles, the free end of which acts as the first stop.

But the stop device can also be made up, as in DE 44 10 599, of customized devices, or units, which provide specific and independent support around each stub, because such units generate fewer damaging lateral forces for the anode leg. The device presented in the example detailed below is made up of customized devices, less cumbersome than those in DE 44 10 599. It also has the special feature of having a first stop made up of an assembly of facets laid out regularly around each stub. In the following example, these facets, with a very low surface area, are placed at the ends of pins laid out regularly around a crown, the top face of the base of this crown also being used as intermediate axial top. Since said pins are not in line with the means of the attacking device, bending stresses are generated in the carbon block, which make it easier to break up the butt.

In the example given below, said unit comprises an external sleeve and an internal sleeve which can move inside said external sleeve, the top end of said external sleeve being interdependent of the frame of the machine, the bottom end of said external sleeve partially surrounding the related stub and having a face that acts as a first stop, said internal sleeve having an end wall which, when said internal sleeve comes up axially against a wall interdependent of the frame of the machine, acts as said second stop. In addition, the lower end of the outer sleeve is provided with axial pins whose end face acts as the first stop. Said internal sleeve consists of a pair of jaws which can be opened to let the transverse arms of the anode leg through.

The spent anode (or the rejected new anode) is moved, either by the attacking device, or by a special actuator, until the butt come up axially against the first stop. The attacking device causes the lower part of the anode butt to move, while its upper part is blocked. This imposes loads on said butt such that it breaks up and fragments break away from the butt one after another. As indicated previously, this first phase of butt fragmentation is advantageously carried out using special means, typically knives, which, for example, are laid out in one or more planes of symmetry of the spatial layout of the stubs.

To facilitate butt fragmentation in a zone far from the stub, the stop device is advantageously provided with axial pins pointing downwards and regularly laid out around the stubs. The end face of these pins can constitute said first stop.

When most of the butt is broken up and detached, there remain portions that are still attached near the stubs which, because of this, are not immobilized by the first stop. As the attacking device continues to move forward, the axial protuberances finally come into contact with the residual butt and, working in line with the stubs, cause them to move axially. As long as the thimbles are not immobilized by the second stop, the residual butt is subjected to shearing forces primarily due to friction against the side wall of the recess. In this way fragmentation of the remaining pieces of butt attached around the stub is completed. At this stage of the process the advantage of a large axial offset between the first stop and the second stop may be noticed; this makes it possible to complete anode butt stripping without risk of the thimbles breaking away. According to the invention, an axial shift is chosen that is greater or substantially equal to the height of the thimbles, i.e. typically higher than half the height of said thimbles and preferably at least equal to said height.

This shift also makes it possible to define an amount of time during which it may be decided to stop the forward movement and even to move slightly backwards, typically over a distance of about half the height of the thimbles, to facilitate detachment and to allow the last fragments of butt to be collected and removed to the crushing devices and the carbon block manufacturing plant. Once this waste has been removed from the reception area, the attacking device is once again set in motion: it continues to move axially so that the thimbles end up by being blocked by the second stop.

When the thimble is immobilized by the second wall, the axial protuberance of the attacking device continuing to move forward, a large shearing force is built up, which acts directly at the boundary between stub and thimble and said thimble ends up by being detached from the stub. As the axial protuberances are designed so as not to retain the thimble, this falls towards the reception area which has just been cleared of butt fragments and all that remains is to remove said thimbles which are split up, shot-blasted and then sent to the smelting furnaces.

So with the axial shift between the first stop and the second stop, anode butt stripping is finished by means of weak shearing movements, avoiding any risk of inopportune detachment of the thimbles. In this way, the anode butt fragmentation stage and the stage involving ripping out the thimbles are more easily separated, while being surer of recovering only carbon fragment during the first stage. In addition, a large axial shift between the two stops makes it possible to avoid the use of slender—and therefore fragile—punches, or of additional devices, such as electromagnets to retain the thimbles. With the process according to the invention, there is no need to use any means other than gravity to move away waste as it breaks away from the remains of the anode. The separation of waste is carried out automatically by the effective separation in time between the two operations: anode butt stripping followed by thimble stripping. It is thus possible to design an inexpensive, simply designed sorting device: waste can either be directed as it falls to a destination specific to the nature of waste falling, or a common reception area can be used in conjunction with at least one means of removal which directs said waste towards a destination specific to the nature of the waste.

One can, for example, place under the remaining fragments of anode, preferably under the attacking device, an oblique wall which stops carbon waste from falling and makes it rebound in a given direction. When the first operation (anode butt stripping) is finished, said oblique wall is swiveled round so that the thimbles are projected in a different direction, preferably the opposite one.

A preferred embodiment of the invention has an anode butt stripping and thimble stripping device with an integrated sorting device including a common reception plate which makes it possible to collect carbon waste and the thimbles and on which a scraper runs to-and-fro in the following cycle:

a) after the first operation (anode butt stripping), the scraper is actuated by a transverse movement to push the carbon waste towards the first transfer area which is outside the waste reception area and where the butt fragments are brought to the carbon block preparation department, typically via a conveyor belt circulating nearby, for example along a side face of the machine;
b) during the second operation (thimble stripping), the scraper remains motionless in this first transfer area
c) after the second operation, the scraper is actuated by a transverse movement in the opposite direction to the previous one to cross the waste reception area again and to push the thimbles towards the second transfer area, which is outside the waste reception area and where the thimbles are carried towards the smelting furnaces, typically via a conveyor belt circulating nearby, for example along a side face of the machine;
d) the scraper remains motionless in this second transfer area during the first operation (anode butt stripping) of the following cycle

Advantageously, the reception table consists of a frame anchored in the ground, which has a sturdy table on its top part. These two parts are fixed to each other via an elastic connection, typically rubber shock absorbing studs, which absorb the impacts as waste falls. Preferably also, the entire device is provided with a de-dusting network, in particular the anode stripping zone, the waste reception area of and the zones in which waste falls on the removal conveyors which are fully hooded and connected to said de-dusting network.

Another subject of the invention is an anode butt stripping and thimble stripping machine making it possible to implement the process according to the invention described above, able to strip both spent anodes and rejected new anodes, including a stop device and an attacking device, said attacking device being moveable using an actuator in the direction of said stop device, said stop device surrounding, at least partially, each stub of the anode stem leg and presenting first stop blocking the advance of the butt, said stop device being provided, around each stub, with a recess presenting a second stop which stops said thimbles from moving forward, said machine being characterized in that the axial distance between said first stop and said second stop is higher or substantially equal to the height of said thimbles.

This machine may have the additional characteristics or variants described above and in the example below, in particular the stop device including units made up of an outer sleeve and an inner sleeve sliding inside the outer sleeve, the attacking device having knives laid out in at least one plane of symmetry of the stubs and punches laid out in line with the stubs, the attacking device moved by a set of actuators not located in the waste reception area and the sorting device integrated into said machine, including a scraper moving to and fro.

### FIGURES

FIG. 1 represents schematically, as a low-angle perspective, the interior of a particular machine used to implement the process according to the invention, illustrated at the moment when the spent anode—or the rejected new anode (shown here)—is fitted into the machine, between the attacking device and the stop device.

FIG. 2 details schematically, as a low-angle perspective, a unit of the stop device of the machine illustrated in FIG. 1. The stem and the anode leg are shown as a wire-frame representation, except for the stub associated with said unit. Two different stages of the process are shown:

(2a) the launching phase, before the spent anode arrives axially up against the first stop and

(2b) the beginning of the thimble stripping phase, when the thimbles arrive axially up against the second stop

FIG. 3 illustrates schematically, as a low-angle perspective, the same device at a phase prior to that in FIG. 2b), the attacking device being this time represented. This prior phase corresponds to the start of the rise of the stubs provided with their sleeve or “gangue” of carbonaceous material (not shown) inside the recesses of the stop device.

FIG. 4 illustrates front view of a device integrated into the previous machine which makes it possible, by means of a scraper, to separately remove the fragments of butt and the thimbles.

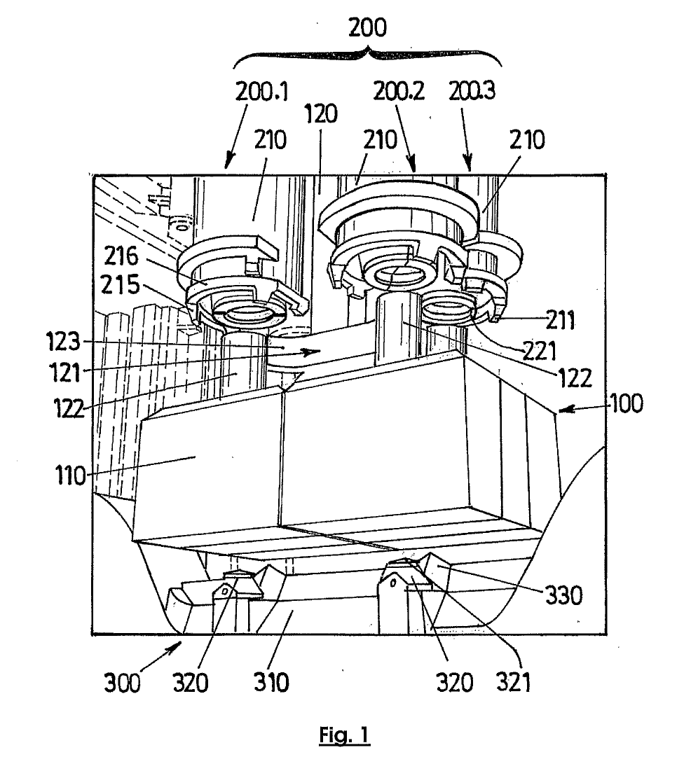

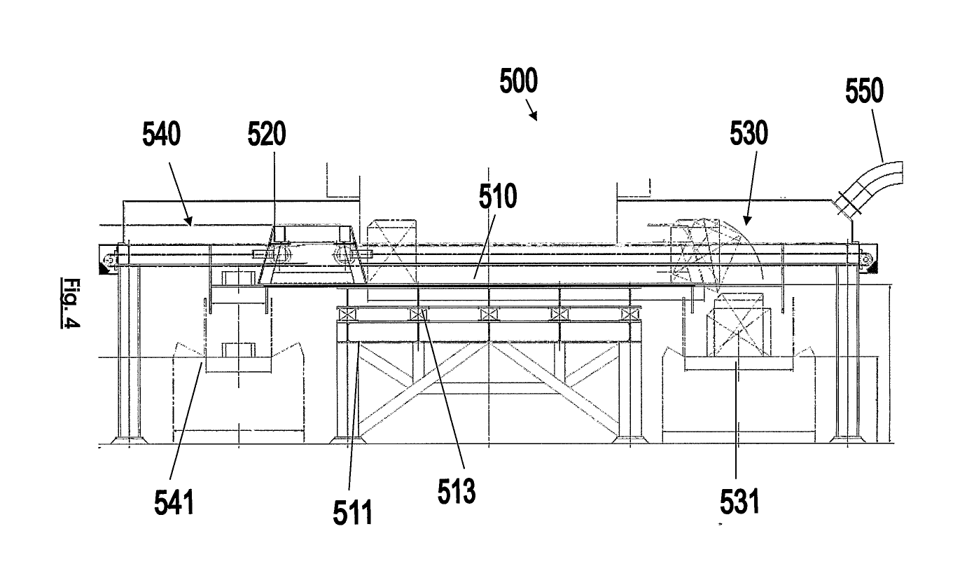

### EXAMPLE (FIGS. 1 TO 4)

The process according to the invention is described here based on a particular machine, illustrated in FIGS. 1 to 4, used to implement it.

The spent anode 100 includes a stem 120 made of conducting metal and a butt 110 made of carbonaceous material. The connection between the stem and the carbonaceous material body is made via a steel leg 121, interdependent of the base of the stem and which is in general in the shape of an upside-down candelabrum, each branch 123 of the candelabrum being associated with a stub 122. In the particular case of this example, the carbonaceous body is fixed to the stem via 4 stubs 122. The mechanical and electric connection between the carbonaceous body and each stub is made by a cast iron thimble 130.

The spent anode 100 is inserted vertically into the anode butt stripping and thimble stripping machine. The butt 110 and the anode leg 120 are inserted between a stop device 200 and an attacking device 300.

The attacking device 300 is driven by a set of jacks (not shown) acting vertically. To avoid encumbering the reception table, the jacks are offset and work on a thick beam 310 the length of which is greater than that of the butt 110. This beam 310 is actuated by two jacks working at each end of said beam (not shown), thus creating a free space without any obstacles under said beam, able to collect waste which has been detached from the remaining anode fragment and has fallen.

The attacking device has punches 320 which are presented substantially in line with each stub 122. Here, there are two different means of attack: pointed protuberances and knives 330 which are not placed in line with the stubs and said punches 320 which appear as tapers with a low slenderness ratio, with a round end 321 which has a diameter of attack lower than that of stubs 122. When the butt is sufficiently broken up, these punches arrive in the vicinity of the base of the stubs, in line with them. They cause the stubs and their residual gangues of carbonaceous material to go up inside the boring worked into the outer sleeves 210 of the stop device. The internal sleeves 220 are moved by the stubs, via the thimbles, until they are immobilized by a fixed wall 400, associated with the frame of the machine. The lower wall 221 of the internal sleeves then acts as second stop 225.

The pointed protuberances are arranged according to a plane of symmetry of the geometrical configuration made up by the layout of the four stubs 122, which allows the butt to be attacked evenly and avoids the formation of lateral forces likely to bend the stem leg 121, or even the anode stem 120.

The stop device 200 here is a set of four customized units (200.1, 200.2, 200.3, 200.4), each one partially surrounding a stub 122 so that said stub and the transverse arm 123 of the stem leg which is associated with it can move freely in the vertical direction.

Each unit is made up of an outer sleeve 210 the top end of which is interdependent of the machine frame and the bottom end 216 of which is in the shape of a crown partially surrounding the associated stub 122. This bottom end is provided with pins 215 whose lower face is part of the first stop 211 which stops the butt 110 from moving forward. Typically, all the lower faces of the pins occupy a surface representing between 10 and 20% of the surface of the bottom end 216. An axial notch worked into the outer sleeve 210 and extending as far as said first stop allows the transverse arm 123 of the anode leg to move freely in the vertical direction.

Each unit also includes an inner sleeve 220, made up of a pair of jaws 2201 and 2202. The inner sleeve 220 can move inside the outer sleeve 210 over a distance H at least equal to the height of the thimbles. When the inner sleeve 220 comes up axially against wall 400, the end wall 221 acts as the second stop 225. In this latter geometrical configuration, the inside of the outer sleeve 210 constitutes a recess 230 which has a second stop 225.

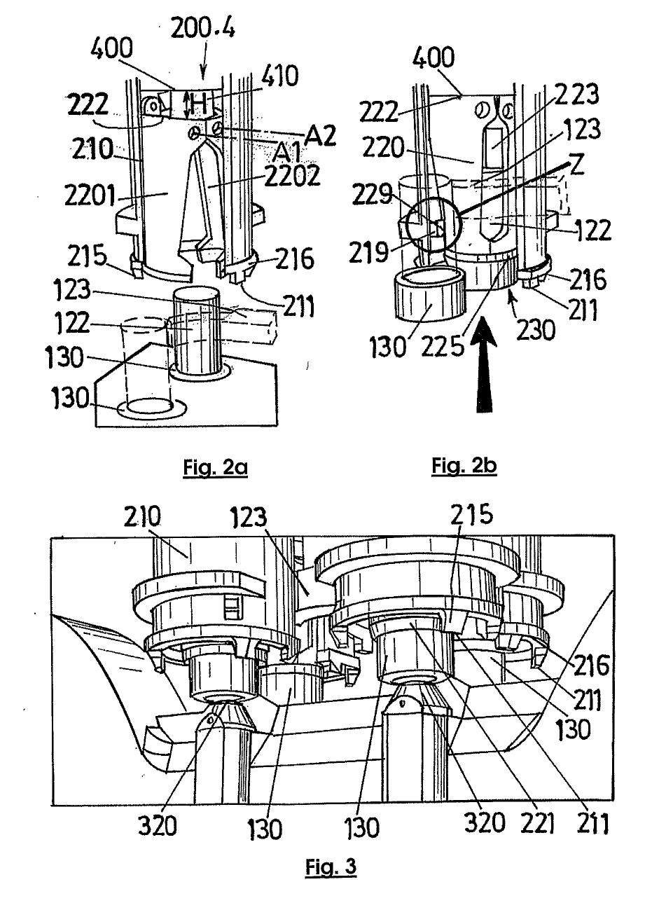

When the anode butt 110 is fitted between the attacking device 300 and the stop device 200 (FIG. 2a), jaws 2201 and 2202 are open in order to let the transverse arms 123 of the anode leg through. When jaws 2201 and 2202 are closed, they form a second sleeve or inner sleeve 220, whose internal diameter is slightly greater than that of stub 122. This inner sleeve 220 also has an axial notch 223 which allows the transverse branch 123 of the anode leg to move freely. But, here, jaws 2201 and 2202 have their bottom ends joined together, forming a lower wall 221 which completely surrounds stub 122 and which has a boring whose internal diameter, similar to that of the diameter of the stubs, is considerably less than the external diameter of the thimbles. In this way, the thimbles drive the inner sleeve 220 as they rise. Jaws 2201 and 2202 swivel around horizontal axes A1 and A2, interdependent of a stem 410 which can slide with a substantial amount of play inside wall 400. The set of jaws 2201 and 2202, and stem 410 constitutes a flexible assembly which allows customized centering and alignment of the inner sleeve 220 with the axis of each stub 122.

When the inner sleeve is finally blocked by wall 400, the lower wall 221 of the inner sleeve 220 acts as a second stop 225, by immobilizing thimbles 130. Punch 320 continues to drive stub 122 upwards. The thimble/stub interface is then subjected to a strong shearing force.

With this set of independent stop units (200.1, 200.2, 200.3, 200.4), there is less risk of creating transverse forces due to the fact that the lower faces of the stubs are not exactly at the same level. In addition, in such a case, the stubs associated with the thimbles which are not yet immobilized axially are still free to move axially towards the second stop but they are protected by the inner sleeve 220 which is associated with them and which prevents them from swiveling or shearing off under the effect of said lateral forces.

The resistance of the inner sleeve 220 to the forces involved in thimble stripping is still further improved if jaws 2201 and 2202 are prevented from opening radially. To achieve this, the outer wall of said jaws is provided with studs 229 which come radially up against pins 219 located on the internal wall of the outer sleeve 210 (see surrounded zone Z in FIG. 2b).

In FIG. 1, no significant axial shift between the first stop 211 and the lower wall 221 is to be observed, because the inner sleeve 220 is located in the bottom part in this configuration. The lower wall 221 does not then act as a stop. The inner sleeve 220 is itself free to move inside the outer sleeve 210 over a height H, until its top end 222 encounters the fixed wall 400, interdependent of the machine frame. When said top end 222 encounters the fixed wall 400, the axial shift between the first stop 211 and the second stop 225 is slightly greater than the height of thimble 130 (130 mm in this case).

These customized units, made up of a sliding inner sleeve inside an outer sleeve interdependent of the machine frame allow an axial reaction suited to the loads imposed in the vicinity of the stub which is associated with them. This has the advantage of generating fewer detrimental lateral forces for the stem and the anode leg. These units taken together make it possible to have a compact stop device.

Stripping occurs as follows:
the spent anode (or the rejected new anode) is moved vertically by an independent actuator which acts directly on the anode stem until butt 110 arrives axially up against the first stop 211; jaws 2201 and 2202 are open to let the transverse arms 123 of the anode legs through, then they are closed again;
The attacking device 300 causes the lower part of the butt 110 to move, while its upper part is blocked. This imposes loads on said butt such that it breaks up and fragments break away from the butt one after another;
the first phase of butt fragmentation is carried out by knives 330; to facilitate butt fragmentation, the lower end 216 of the outer sleeve 210 is advantageously provided with axial pins 215 directed downwards and regularly distributed. The first stop 211 is made up of all the lower faces of the pins 215, which have a low surface area. Said pins are not in line with the means of attacking 330 and 320, and bending stresses are generated in the carbon block, which make it easier to break up the butt.
the bottom end 216 of the outer sleeve 210 can also be used as an intermediate axial stop during butt fragmentation;
When most of the butt is broken up and detached, there remain portions that are still attached near the stubs 122 which, because of this, are not immobilized by the first stop;
as the attacking device continues to move forward, punches 320 finally come into contact with the residual butt and, acting in line with the stubs, force them to be inserted into the recess made by boring the outer sleeve 210, and to take the inner sleeve with them 220. As long as the thimbles are not immobilized, the residual butt is subjected to shearing forces which continue to break it up but these forces, primarily due to friction against the bore of the external sleeve 210, are relatively weak and the risk of ripping out the thimbles is a small one. In this way fragmentation of the remaining pieces of butt attached around the log is completed.
the attacking device 300 is stopped from moving forward roughly when the inner sleeve 220 arrives axially up against the fixed wall 400 and where, as a result, thimbles 130 end up being blocked by the lower wall 221 which then acts as a second stop 225. Typically, the device is stopped when, using a position sensor, it is observed that the top end 222 of the inner sleeve 220 is within a few millimeters of stop 400. The device is slightly pulled backwards to allow detachment and reception of the last fragments of butt; all the carbonaceous waste is removed;
the attacking device is again set in motion; a large shearing force is pstemuced, which bears directly on the boundary between stub 122 and thimble 130; the thimble bends, tears and is finally detached from the stub and falls towards the reception area from which has just been cleared of butt fragments;
the thimbles are taken off to the smelting ovens.

The machine used for this process also has an integrated sorting device 500 including a reception plate 510 for collecting waste and on which a scraper 520 is made to circulate in a to-and-fro motion in a direction perpendicular to the attack beam 310:

a) after the first operation (anode butt stripping), scraper 520 is actuated by a transverse movement to push carbonaceous waste towards a first transfer area 530 where the butt fragments are deposited on a conveyor belt 531 placed along a side face of the machine;
b) during the second operation (thimble stripping), the scraper remains motionless in this first transfer area 530;
c) after the second operation, scraper 520 is actuated by a transverse movement in the opposite direction to the previous one, to go back across the waste reception plate area 510 and to push the thimbles towards a second transfer area 540, where the thimbles are poured onto a conveyor belt 541 placed along the other side face of the machine;
d) the scraper 520 remains motionless in this second transfer area 540 during the first operation (anode butt stripping) of the following cycle.

The reception table consists of a frame 511 anchored in the ground, which has a sturdy table on its top part. These two parts are fixed to each other via rubber shock-absorbing studs 513. The entire device is provided with a de-dusting network 550. In particular, the anode stripping zone, the waste reception area and the zones in which waste falls on the conveyors are fully hooded and connected to the de-dusting network.

Scraper 520 is guided by two sets of two rollers rolling in two U-shaped irons located on both sides of the scraper. It slides on the top surface of the reception plate and is driven by a capstan system with two chains, actuated by a reduction gear fitted at one end of the fixed frame of the table.

1. Process for extracting the anode butt and the thimbles attached to a spent anode, including the following stages:
a) the butt is fitted between a stop device and an attacking device, said attacking device being able to be moved using an actuator in towards said stop device,
said stop device surrounding, at least partially, each stub of the anode stem leg and having a first stop stopping the butt from moving forward, said stop device being provided, around each stub, with a recess having a second stop which stops said thimbles from moving forward;
b) the spent anode is moved until the butt is blocked by said first stop;
c) said attacking device is moved towards the stop device so that it arrives in contact with said anode butt and imposes on said butt such a force as to cause it to break up and the fragments to be detached from the butt;
d) the fragments of butt are removed;
e) said attacking device continues to move so that the thimbles are blocked by the second stop and are detached from the stubs;
f) said attacking device stops and is withdrawn;
said process being characterized in that the axial distance between said first stop and said second stop is higher or substantially equal to the height of said thimbles.

2. A process according to claim 1 characterized in that said recess has a general shape substantially based on a cylinder coaxial to said stub.

3. A process according to claim 1 in which said attacking device is provided with means of attack which include axial protuberances which, at least at the end of stage c) (anode butt stripping) and during stage e) (thimble stripping), are substantially in line with each stub.

4. A process according to claim 1 in which said attacking device is provided with means of attack which include pointed axial protuberances, typically pyramidal, not placed in line with the stubs and of the punches which are substantially in line with each stub, with a round end having a diameter less than that of the stubs.

5. A process according to claim 1 in which said punches are in the shape of a truncated cone and have a low slenderness ratio, with height to average diameter ratio of typically less than 1.

6. A process according to claim 1 in which said stop device is a thick plate, one face of which, corresponding to the first stop, is provided with recesses surrounding the stubs, the bottom of which corresponding to the second stop.

7. A process according to claim 1 in which said stop device is a plate with a face acting as second stop onto which are fixed, around the notches reserved for the stubs and surrounding said stubs at least partially, the axial walls, typically in the shape of a cylinder or prism, the height of which is substantially equal to the height of the thimbles and whose free end acts as the first stop.

8. A process according to claim 1 in which said stop device consists of units which provide specific and independent support around each stub.

9. A process according to claim 1 in which said first stop consists of a set of facets laid out regularly around each stub.

10. A process according to claim 8 in which said unit comprises an external sleeve and an internal sleeve which can move inside said external sleeve, the top end of said external sleeve being interdependent of the frame of the machine, the bottom end of said external sleeve partially surrounding the related stub and having a face that acts as a first stop, said internal sleeve having an end wall which, when said internal sleeve comes up axially against a wall interdependent of the frame of the machine, acts as said second stop.

11. A process according to claim 10 in which the lower end of the outer sleeve is provided with axial pins whose end face acts as the first stop.

12. A process according to claim 1 in which the attacking device is stopped from moving forward at the end of stage c) and is made to move slightly backwards, typically over a distance of about half the height of the thimbles, to facilitate the detachment, reception and removal of the butt fragments.

13. A process according to claim 1 in which all the waste comes away and falls by gravity and is directed as it falls to a destination specific to the nature of the waste falling.

14. A process according to claim 1 in which all the waste comes away and falls by gravity into a common reception area traversed by a means of removal which directs said waste towards a destination specific to the nature the waste received.

15. A process according to claim 14 in which an oblique wall is placed under the anode fragment to bar the fall of carbonaceous waste and make it rebound in a given direction and which is made to swivel when stage c) is finished, so that the thimbles are projected in a direction different from that taken by the butt fragments.

16. A process according to claim 14 in which a sorting device is used including a reception plate which makes it possible to collect carbonaceous waste and the thimbles and on which a scraper is made to circulate in to and fro according to the following cycle:
a) after the first operation (anode butt stripping), the scraper is actuated by a transverse movement to push the carbon waste towards the first transfer area which is outside the waste reception area and where the butt fragments are brought to the carbon block preparation department, typically via a conveyor belt;
b) during the second operation (thimble stripping), the scraper remains motionless in this first transfer area
c) after the second operation, the scraper is actuated by a transverse movement in the opposite direction to the previous one to cross the waste reception zone again and to push the thimbles towards a second transfer area, which is outside the waste reception area and where the thimbles are sent off to the smelting furnaces, typically via a conveyor belt;
d) the scraper remains motionless in this second transfer area during the first operation (anode butt stripping) of the following cycle.

17. A machine used to extract the carbonaceous block from an anode and the thimbles attached to an anode including a stop device and an attacking device, said attacking device being able to be moved using an actuator towards said stop device, said stop device at least partially surrounding each stub of the anode stem leg and having a first stop stopping the butt from moving forward, said stop device being provided, around each stub, with a recess constituting a second stop which stops said thimbles from moving forward, said machine being characterized in that the axial distance between said first stop and said second stop is greater or substantially equal to the height of said thimbles.

18. A machine according to claim 17 characterized in that said recess has a general shape substantially based on a cylinder coaxial to said stub.

19. A machine according to claim 17 in which the side wall of said recess has ridges and/or ribs, typically helix shaped.

20. A machine according to claim 17 in which said attacking device is provided with axial protuberances which are substantially in line with each stub.

21. A machine according to claim 17 in which the attacking device is actuated by a set of jacks located outside the zone in which waste falls and is collected.

22. A machine according to claim 17 in which said attacking device is provided with means of attack which include pointed axial protuberances, typically pyramidal, not placed in line with the stubs and of the punches which are substantially in line with each stub, with a round end having a diameter less than that of the stubs.

23. A machine according to claim 17 in which said punches are in the shape of a truncated cone and have a low slenderness ratio, with height to average diameter ratio of typically less than 1.

24. A machine according to claim 17 in which said stop device consists of units which provide specific and independent support around each stub.

25. A machine according to claim 17 in which said first stop consists of a set of facets laid out regularly around each stub.

26. A machine according to claim 24 in which said unit comprises an external sleeve and an internal sleeve which can move inside said external sleeve, the top end of said external sleeve being interdependent of the frame of the machine, the bottom end of said external sleeve partially surrounding the related stub and having a face that acts as a first stop, said internal sleeve having an end wall which, when said internal sleeve comes up axially against a wall interdependent of the frame of the machine, acts as said second stop.

27. A process according to claim 26 in which the lower end of the outer sleeve is provided with axial pins whose end face acts as the first stop.

28. A machine according to claim 26 in which said internal sleeve consists of a pair of jaws which can be opened to let the transverse arms of the anode leg through.

29. A machine according to claim 17 in which the attacking device is actuated by a set of jacks located outside the zone in which waste falls and is collected.

30. A machine according to claim 17 characterized in that it also includes a sorting device including a reception plate which makes it possible to collect carbonaceous waste and the thimbles and on which a scraper is made to circulate to and fro so that carbonaceous waste is scraped in a given direction and the thimbles are scraped in the opposite direction.
